(19) United States
(12) Patent Application Publication
(10) Pub. No.: US 2017/0060965 A1
(43) Pub. Date: Mar. 2, 2017

(54) SYSTEM, SERVER AND METHOD FOR MANAGING CONTENTS BASED ON LOCATION GROUPING

(71) Applicants: Yonho PARK, Seoul (KR); John Hongkyu PARK, Sacramento, CA (US)

(72) Inventors: Yonho PARK, Seoul (KR); John Hongkyu PARK, Sacramento, CA (US)

(21) Appl. No.: 14/942,631

(22) Filed: Nov. 16, 2015

(30) Foreign Application Priority Data
Sep. 1, 2015 (KR) 10-2015-0123786

(51) Int. Cl. G06F 17/30; H04L 29/08

(52) U.S. Cl. CPC G06F 17/30554; G06F 17/30598; H04L 67/1085

(57) ABSTRACT

Provided is a system, a server and a method for managing contents based on location grouping. The location-grouping contents management server includes a location grouping management unit for grouping a geographic location into a plurality of grouped locations according to a location grouping algorithm, a contents upload management unit for setting at least one contents upload access according to the plurality of grouped locations, and distributing and assigning at least one contents upload access to at least one contents uploader according to an access distribution algorithm.

### FIELD OF THE DISCLOSURE

The present disclosure relates to a system, a server and a method for managing contents based on location grouping, and, more specifically, to a system, a server and a method for managing contents based on location grouping, in which a contents upload access is set according to a plurality of grouped locations and a contents classification, and the contents upload access is distributed and assigned to at least one contents uploader according to an access distribution algorithm.

### BACKGROUND OF THE DISCLOSURE

Generally, most of behaviors and interests of people exist around a specific location such as his or her home or office. That is, since people do a behavior related to an ordinary life including living, staying, working, eating, drinking, and enjoying in a specific location related to himself or herself, information on the specific location like this is needed in many occasions.

Conventionally, if anyone has a question related to a specific field in a specific location, a general way of searching for the information is to use an existing internet portal site.

However, a conventional internet portal site collects information on a web site previously posted on the internet and responds to a search request when information on a specific location is collected. Thus, when a search request related to a specific field in a specific location is received, the general internet portal site cannot provide a satisfied result in response to the search request. That is because an existing internet portal site is not specialized to a specific field in a specific location. In addition, an existing internet portal site does not generate specialized contents for a variety of fields of a variety of locations by itself. The existing internet portal site fails to provide detailed information on a specific field in a specific location and merely collects and shows web information posted in an existing internet space.

Accordingly, a technique capable of providing detailed contents of a specific field in a specific location is required to overcome the problems of the conventional internet portal sites.

### SUMMARY OF THE DISCLOSURE

Therefore, the present disclosure has been made in view of the above problems, and it is an object of the present disclosure to provide a system, a server and a method for managing contents based on location grouping, in which a contents upload access is set according to a plurality of grouped locations and a contents classification, and the contents upload access is distributed and assigned to at least one contents uploader according to an access distribution algorithm.

To accomplish the above object, according to one aspect of the present disclosure, there is provided a location-grouping contents management system including: a location-grouping contents management server; at least one contents upload terminal; and at least one user terminal, in which the location-grouping contents management server comprises: a location grouping management unit for grouping a geographic location into a plurality of grouped locations according to a location grouping algorithm; and a contents upload management unit for setting at least one contents upload access according to the plurality of grouped locations and at least one contents classification, and distributing and assigning the at least one contents upload access to at least one contents uploader according to an access distribution algorithm; in which the at least one contents upload terminal corresponds to the at least one contents uploader and communicates with the location-grouping contents management server to upload contents corresponding to the contents upload access assigned to the corresponding contents uploader, and the at least one user terminal transmits search request information received from a user to the location-grouping contents management server and receives contents corresponding to the search request information among the contents uploaded onto the location-grouping contents management server.

According to another aspect of the present disclosure, there is provided a location-grouping contents management server including: a location grouping management unit for grouping a geographic location into a plurality of grouped locations according to a location grouping algorithm; and a contents upload management unit for setting at least one contents upload access according to the plurality of grouped locations, and distributing and assigning at least one contents upload access to at least one contents uploader according to an access distribution algorithm.

Preferably, the contents upload management unit may set the at least one contents upload access according to the plurality of grouped locations and at least one contents classification.

Preferably, the location-grouping contents management server may further include a server communication unit for receiving a contents upload request from a contents upload terminal, in which the contents upload management unit may confirm a contents upload access corresponding to the contents upload request and permit or reject the contents upload request according to the confirmed contents upload access.

In addition, preferably, the location-grouping contents management server may further include a contents search management unit for providing, when the server communication unit receives search request information from a user terminal, the user terminal with contents corresponding to the search request information.

In addition, preferably, the location-grouping contents management server may further include a software application distribution management unit for distributing and managing a software application for connecting the user terminal to the location-grouping contents management server, in which the user terminal may transmit the search request information to the location-grouping contents management server and receive contents corresponding to the search request information through the software application downloaded from the software application distribution management unit.

According to another aspect of the present disclosure, there is provided a location-grouping contents management method including the steps of: grouping a geographic location into a plurality of grouped locations according to a location grouping algorithm, by a location grouping management unit; setting at least one contents upload access according to the plurality of grouped locations, by a contents upload management unit; and distributing and assigning at least one contents upload access to at least one contents uploader according to an access distribution algorithm, by the contents upload management unit.

According to another aspect of the present disclosure, there is provided a location-grouping contents management method including the steps of: grouping a geographic location into a plurality of grouped locations according to a location grouping algorithm, by a location grouping management unit; setting at least one contents upload access according to the plurality of grouped locations and at least one contents classification, by a contents upload management unit; and distributing and assigning at least one contents upload access to at least one contents uploader according to an access distribution algorithm, by the contents upload management unit.

Preferably, the location-grouping contents management method may further include the step of confirming, when a server communication unit receives a contents upload request from a contents upload terminal, a contents upload access corresponding to the contents upload request and permitting or rejecting the contents upload request according to the confirmed contents upload access, by the contents upload management unit.

In addition, preferably, the contents upload request may be generated by the contents upload terminal according to a contents upload form provided by the contents upload management unit.

In addition, preferably, the location-grouping contents management method may further include the step of providing, when the server communication unit receives search request information from a user terminal, the user terminal with contents corresponding to the search request information, by a contents search management unit.

In addition, preferably, the search request information may include location selection information corresponding to at least one of the plurality of grouped locations, and the location selection information may be received from the user through the user terminal or the location selection information corresponds to a geographical location of the user terminal.

In addition, preferably, the location grouping algorithm may group the geographic location according to at least one of latitude, longitude, administrative district, zip code and address.

In addition, preferably, the contents upload management unit may receive at least one access assignment application from the contents upload terminal of the at least one contents uploader, and if the at least one access assignment application is overlapped in any one of the grouped location and the contents classification, the contents upload management unit may assign a contents upload access corresponding to the any one of the grouped location and the contents classification to at least one of contents uploaders transmitting the overlapped access assignment application according to the access distribution algorithm.

In addition, preferably, the access assignment application may include information on a grouped location selected among the plurality of grouped locations and information on a contents classification selected in the selected grouped location.

According to another aspect of the present disclosure, a non-statutory computer-readable medium for location-grouping contents management method is provided. The non-statutory computer-readable medium includes instructions that when executed on a processor, perform grouping a geographic location into a plurality of grouped locations according to a location grouping algorithm, by a location grouping management unit, setting at least one contents upload access according to the plurality of grouped locations and at least one contents classification, by a contents upload management unit, and distributing and assigning the at least one contents upload access to at least one contents uploader according to an access distribution algorithm, by the contents upload management unit.

### BRIEF DESCRIPTION OF THE DRAWINGS

FIG. 1 is a brief block-diagram depicting a location-grouping contents management system according to an embodiment of the present disclosure.

FIG. 2 is a flowchart illustrating a location-grouping contents management method according to the embodiment of the present disclosure.

FIG. 3 is a flowchart illustrating a location-grouping contents management method according to another embodiment of the present disclosure.

FIG. 4 illustrates a map for an explanation of a location grouping algorithm according to an embodiment of the present disclosure.

FIG. 5 illustrates a map for an explanation of a location grouping algorithm according to another embodiment of the present disclosure.

FIG. 6 illustrates a map for an explanation of a location grouping algorithm according to another embodiment of the present disclosure.

FIG. 7 illustrates a map showing a screen provided on a contents upload terminal according to an embodiment of the present disclosure.

FIG. 8 illustrates a table and picture showing a contents upload form according to an embodiment of the present disclosure.

### DETAILED DESCRIPTION

In order to fully understand the present disclosure, operational advantages of the present disclosure and objects achieved by the implementation of the present disclosure, the accompanying drawings illustrating the embodiments of the present disclosure and the contents described in the accompanying drawings need to be referred to.

The present disclosure will be described hereinafter in detail by describing the preferred embodiments of the present disclosure. Like reference numerals presented in each of the drawings denotes like elements.

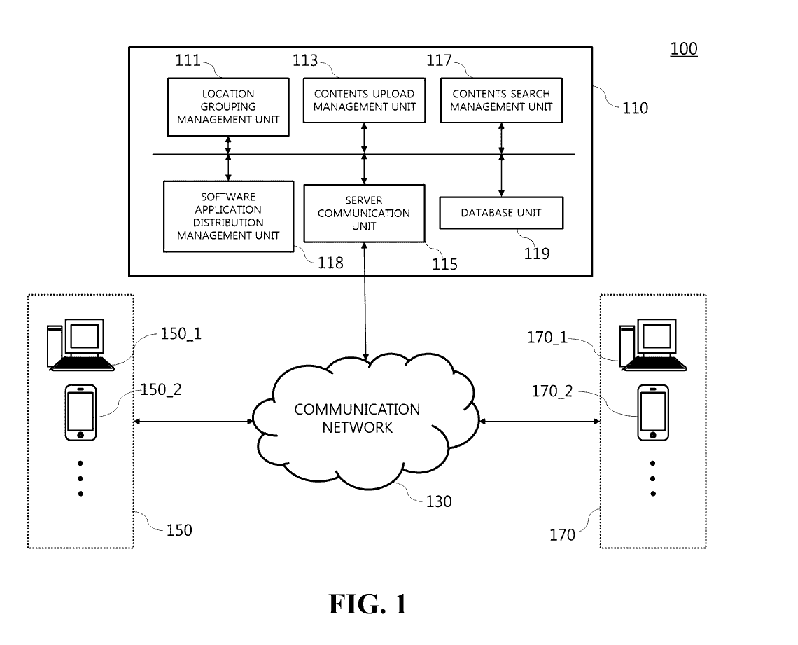

FIG. 1 is a brief block-diagram depicting a location-grouping contents management system according to an embodiment of the present disclosure. Referring to FIG. 1, the location-grouping contents management system 100 according to an embodiment of the present disclosure includes a location-grouping contents management server 110, at least one contents upload terminal 150 and at least one user terminal 170. As shown in FIG. 1, the location-grouping contents management server 110, the at least one contents upload terminal 150 and the at least one user terminal 170 has either wired or wireless connection with each other using a wired or wireless communication network 130. Since the wired or wireless communication network 130 is a communication network capable of wired or wireless communication and widely known to those skilled in the art, detailed description thereof is omitted.

The location-grouping contents management server 110 may include a location grouping management unit 111 and a contents upload management unit 113. In addition, according to embodiments, the location-grouping contents management server 110 may further include a server communication unit 115, a contents search management unit 117, a software application distribution management unit 118, and a database unit 119.

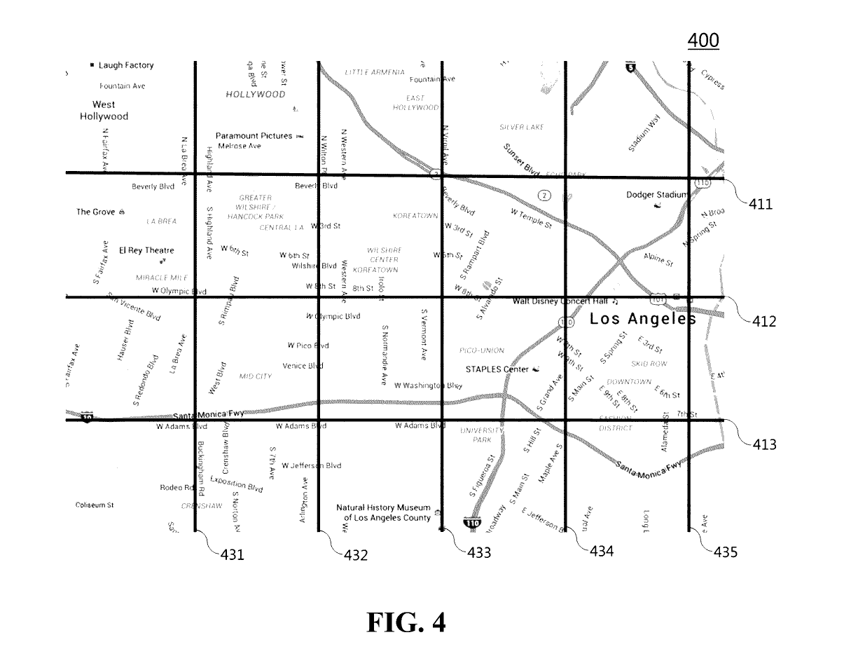

The location grouping management unit 111 may group a specific geographic location into a plurality of grouped locations according to a location grouping algorithm. For example, the location grouping algorithm may be an algorithm for grouping a specific geographic location according to at least one of latitude, longitude, administrative district, zip code, and address. A specific description of the location grouping algorithm will be described in detail with reference to FIGS. 4 to 6, and detailed description thereof is omitted here. Data on the plurality of grouped locations generated by the location grouping management unit 111 may be stored in the database unit 119.

The contents upload management unit 113 may set at least one contents upload access according to the plurality of grouped locations grouped by the location grouping management unit 111. In addition, the contents upload management unit 113 may set at least one contents upload access according to the plurality of grouped locations and at least one contents classification. In addition, the contents upload management unit 113 may distribute and assign the at least one contents upload access to at least one contents uploader according to an access distribution algorithm. Hereinafter, an embodiment of setting at least one contents upload access according to the plurality of grouped locations and at least one contents classification by the contents upload management unit 113 will be described in detail.

For example, it may be assumed as shown in Table 1 that the location grouping management unit 111 groups a specific location into three grouped locations A1, A2 and A3, and there are two contents classifications of real estate and restaurant, while contents upload accesses are distributed and assigned to three contents uploaders. The data shown in Table 1 may be stored in the database unit 119.

TABLE 1

| Contents | Grouped | Contents | Contents |
|---|---|---|---|
| upload access | location | classification | uploader |
| R1 | A1 | Real estate | U1 |
| R2 | A1 | Restaurant | U2 |
| R3 | A2 | Real estate | U1 |
| R4 | A2 | Restaurant | U2 |
| R5 | A3 | Real estate | U1 |
| R6 | A3 | Restaurant | U3 |

Here, a first contents upload access R1 may be an access capable of uploading real estate contents of a first grouped location A1, and a second contents upload access R2 may be an access capable of uploading restaurant contents of the first grouped location A1. In the same way, a third contents upload access R3 may be an access capable of uploading real estate contents of a second grouped location A2, a fourth contents upload access R4 may be an access capable of uploading restaurant contents of the second grouped location A2, a fifth contents upload access R5 may be an access capable of uploading real estate contents of a third grouped location A3, and a sixth contents upload access R6 may be an access capable of uploading restaurant contents of the third grouped location A3. Here, the real estate contents may be contents including information on sale or lease of real estate, and the restaurant contents may be contents including information on a restaurant, such as a location, menus, prices, business hours and the like of the restaurant.

In addition, according to an access distribution algorithm which will be described below, the first contents upload access R1, the third contents upload access R3 and the fifth contents upload access R5 may be assigned to the first contents uploader U1, the second contents upload access R2 and the fourth contents upload access R4 may be assigned to the second contents uploader U2, and the sixth contents upload access R6 may be assigned to the third contents uploader U3, as shown in Table 1. According to embodiments, the contents upload management unit 113 may assign a contents upload access for a plurality of grouped locations to one contents uploader or assign a contents upload access for a same grouped location and a same contents classification to a plurality of contents uploaders.

Then, when the server communication unit 115 receives a contents upload request from at least one contents upload terminal 150, the contents upload management unit 113 may confirm a contents upload access corresponding to the contents upload request and either permit or reject the contents upload request according to the confirmed contents upload access. For example, if the first contents uploader U1 transmits a contents upload request for uploading real estate contents of the first grouped location A1 to the server communication unit 115 using a first contents upload terminal 150_1, the contents upload management unit 113 may confirm, through the database unit 119, that the first contents uploader U1 possesses the first contents upload access R1 capable of uploading the real estate contents of the first grouped location A1 and permit the contents upload request of the first contents uploader U1. Accordingly, the real estate contents of the first grouped location A1 can be uploaded according to the information included in the contents upload request of the first contents uploader U1.

Contrarily, if the second contents uploader U2 transmits a contents upload request for uploading real estate contents of the first grouped location A1 to the server communication unit 115 using a second contents upload terminal 150-2, the contents upload management unit 113 may confirm, through the database unit 119, that the second contents uploader U2 does not possess the first contents upload access R1 capable of uploading the real estate contents of the first grouped location A1 and reject the contents upload request of the second contents uploader U2.

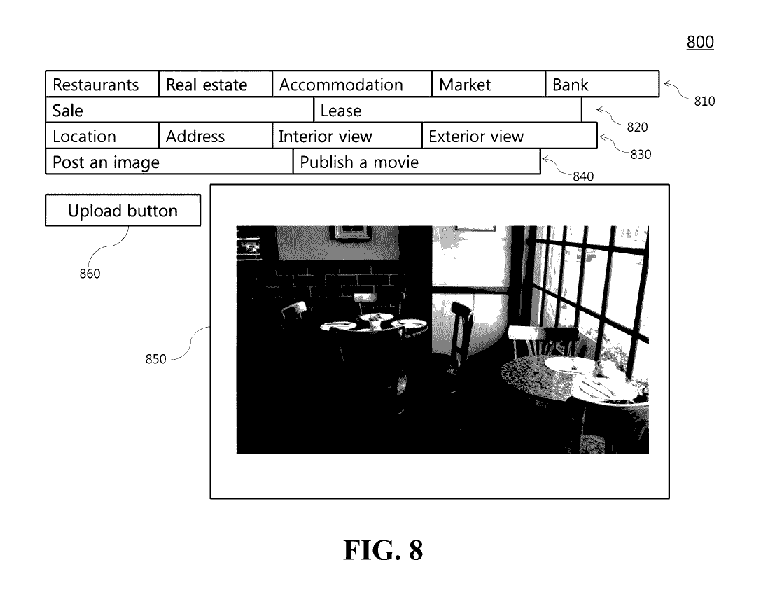

The contents upload request may be generated in the contents upload terminal 150 by a contents uploader according to a contents upload form provided by the contents upload management unit 113. The contents upload form will be described below in detail with reference to FIG. 8, and detailed description thereof is omitted here.

Next, the access distribution algorithm for distributing and assigning at least one contents upload access to at least one contents uploader by the contents upload management unit 113 is described in detail.

The contents upload management unit 113 may receive at least one access assignment application from the contents upload terminal 150 of at least one contents uploader through the server communication unit 115. That is, the contents uploader may connect to a web site provided by the contents upload management unit 113 through its own contents upload terminal 150 or transmit an access assignment application to the server communication unit 115 through an application downloaded from the software application management unit 118. The access assignment application may include information on a grouped location selected among the plurality of grouped locations grouped by the location grouping management unit 111 and information on a contents classification selected in the selected grouped location. That is, the contents uploader may select a grouped location and a contents classification for acquiring a contents upload access and transmit an access assignment application to the server communication unit 115 through its own contents upload terminal 150.

For example, when the first contents uploader U1 selects the first grouped location A1 and the real estate contents and submits an access assignment application for the first contents upload access R1 and the other contents uploaders do not submit an access assignment application, the contents upload management unit 113 may request the first contents uploader U1 to make a payment for the first contents upload access R1, and if the first contents uploader U1 makes a payment for the first contents upload access R1 through its own contents upload terminal 150_1, the contents upload management unit 113 may assign the first contents upload access R1 to the first contents uploader U1 and store information on the assignment of the first contents upload access R1 in the database unit 119. For example, the payment amount for acquiring the first contents upload access R1 may be calculated according to a period of assigning the first contents upload access R1, the grouped location A1 of the first contents upload access R1, importance of the contents classification (e.g., real estate contents) or the like. The longer the period of assigning the first contents upload access R1, the larger the payment amount for acquiring the first contents upload access R1 may be, and the more active the circulation and dealing of the real estate contents in the grouped location A1, the payment amount for acquiring the first contents upload access R1 may be increased. A payment amount corresponding to each contents upload access may be stored in the database unit 119 in advance.

On the other hand, if at least one access assignment application submitted by at least one contents uploader is overlapped in any one of the grouped location and the contents classification, the contents upload management unit 113 may assign a contents upload access corresponding to any one of the grouped location and the contents classification to at least one of the contents uploaders transmitting the overlapped access assignment application according to an access distribution algorithm. For example, the contents upload management unit 113 may apply a bidding method of assigning a contents upload access corresponding to the overlapped access assignment application to a contents uploader offering a larger payment amount among the contents uploaders transmitting the overlapped access assignment application. In addition, the contents upload management unit 113 may apply a first-come-first-served method of assigning a contents upload access corresponding to the overlapped access assignment application to a contents uploader whose time point of submitting the access assignment application is earlier than those of the other contents uploaders transmitting the overlapped access assignment application. Other than these, the contents upload management unit 113 may select at least one of the contents uploaders transmitting the overlapped access assignment application and assign a contents upload access in a variety of methods. According to embodiments, the contents upload management unit 113 may assign any one of the contents upload accesss to one contents uploader or to a plurality of contents uploaders in common.

On the other hand, if an expiry of the period of assigning a contents upload access generates, the contents upload management unit 113 may withdraw the contents upload access. The contents upload management unit 113 may reassign the withdrawn contents upload access to another contents uploader through the operation described above.

The server communication unit 115 may have wired or wireless communication with at least one contents upload terminal 150 and at least one user terminal 170 through the wired or wireless communication network 130 to exchange data. The server communication unit 115 may receive a contents upload request from the at least one contents upload terminal 150 and may receive search request information from the at least one user terminal 170. The server communication unit 115 may be implemented in a wired internet communication module supporting TCP/IP or the like or a communication module supporting at least one of various wireless communication methods such as Wideband Code Division Multiple Access (WCDMA), Long Term Evolution (LTE), Wireless Broadband Internet (WiBro), Wireless Fidelity (WiFi) and the like. The server communication unit 115 may be implemented in a communication module supporting at least one of the various communication methods described above and may be diversely modified within a scope known to those skilled in the art.

When the server communication unit 115 receives the search request information from the at least one user terminal 170, the contents search management unit 117 may provide the user terminal 170 with contents corresponding to the search request information.

For example, a first user may connect to a web site provided by the contents search management unit 117 through a first user terminal 170_1 and transmit the search request information to the server communication unit 115. The first user may transmit the search request information to the server communication unit 115 through an application downloaded from the software application management unit 118. The search request information may include location selection information corresponding to at least one of the plurality of grouped locations grouped by the location grouping management unit 111. In addition, the search request information may further include contents classification selection information corresponding to the contents desired to be obtained by the user.

Here, the location selection information may be received from the first user through the first user terminal 170_1 or correspond to the location of the first user terminal 170_1. That is, the first user terminal 170_1 may receive information on a plurality of grouped locations through the web site or the application, and the first user may select at least one of the plurality of grouped locations and generate the location selection information. According to embodiments, the plurality of grouped locations that the first user receives through the first user terminal 170_1 may be grouped locations grouped in a method different from the method of grouping a location to set at least one contents upload access.

In addition, the first user terminal 170_1 may generate location selection information corresponding to a location of the first user terminal 170_1 through a location-based service. In addition, a plurality of pieces of location selection information may be included in the search request information.

After selecting a location and a contents classification desired to search and creating the search request information through the first user terminal 170_1, the first user may transmit the search request information to the server communication unit 115. Accordingly, the contents search management unit 117 may provide the user terminal 170 with contents corresponding to the search request information. For example, when the first user selects the first grouped location A1 and a contents classification of restaurant, the contents search management unit 117 may provide the first user terminal 170_1 with contents related to restaurants of the first grouped location A1 stored in the database unit 119.

In addition, the search request information may further include contents sub-classification information, keyword information, period information and the like. That is, the user may search for contents of a further detailed classification according to the contents sub-classification information, may search for contents containing a keyword input by the user according to the keyword information, and may search for contents corresponding to a specific period desired by the user to search for the contents according to the period information.

The software application distribution management unit 118 may distribute and manage a software application for connecting the at least one user terminal 170 to the location-grouping contents management server 110. The at least one user terminal 170 may download a software application for connecting to the location-grouping contents management server 110 through the software application distribution management unit 118.

The database unit 119 may store a variety of data needed for operation of the location-grouping contents management server 110, such as information on a plurality of grouped locations, information on members such as contents uploaders, users and the like, information on assignment of a contents upload access and the like and can be implemented by various data storage devices known to those skilled in the art.

Meanwhile, the location grouping unit 111, the contents upload management unit 113, the contents search management unit 117 and the software application distribution management unit 118 are parts of the location-grouping contents management server 110, and they can be implemented and operated by a software application stored and executed in the location-grouping contents management server 110.

At least one contents upload terminal 150 may correspond to at least one contents uploader and communicate with the location-grouping contents management server 110 to upload contents corresponding to the contents upload access assigned to the corresponding contents uploader. Each contents uploader may connect to the location-grouping contents management server 110 and join as a member through its own contents upload terminal, and information on joining as a member may be stored in the database unit 119.

The at least one contents upload terminal 150 may be implemented in the form of various terminals or electronic devices capable of performing wired or wireless data communication, such as a user computer (personal computer, PC), a cellular phone, a smart phone, a table PC, a vehicle navigator or the like, and may be diversely changed within a scope known to those skilled in the art. Although only the first contents upload terminal 150_1 and the second contents upload terminal 150_2 are shown in FIG. 1, this is only for illustrative purpose, and the location-grouping contents management system 100 according to an embodiment of the present disclosure may include three or more contents upload terminals.

At least one user terminal 170 may transmit the search request information received from the user to the location-grouping contents management server 110 and receive contents corresponding to the search request information among the contents uploaded onto the location-grouping contents management server 110. Each user may connect to the location-grouping contents management server 110 and join as a member through its own user terminal, and information on joining as a member may be stored in the database unit 119. However, this is only for illustrative purpose, and each user may connect to the location-grouping contents management server 110 and search for contents without a separate procedure of joining as a member.

The at least one user terminal 170 may transmit the search request information to the location-grouping contents management server 110 and receive contents corresponding to the search request information through a software application downloaded from the software application distribution management unit 118. The at least one user terminal 170 may be implemented in the form of various terminals or electronic devices capable of performing wired or wireless data communication, such as a user computer (PC), a cellular phone, a smart phone, a table PC, a vehicle navigator or the like, and may be diversely changed within a scope known to those skilled in the art. Although only the first user terminal 170_1 and the second user terminal 170_2 are shown in FIG. 1, this is only for illustrative purpose, and the location-grouping contents management system 100 according to an embodiment of the present disclosure may include three or more user terminals.

Meanwhile, in the embodiment of setting at least one contents upload access according to the plurality of grouped locations by the contents upload management unit 113, information on contents classification may be omitted from Table 1. Since specific operations of the embodiment can be inferred from the descriptions described above, detailed description thereof is omitted.

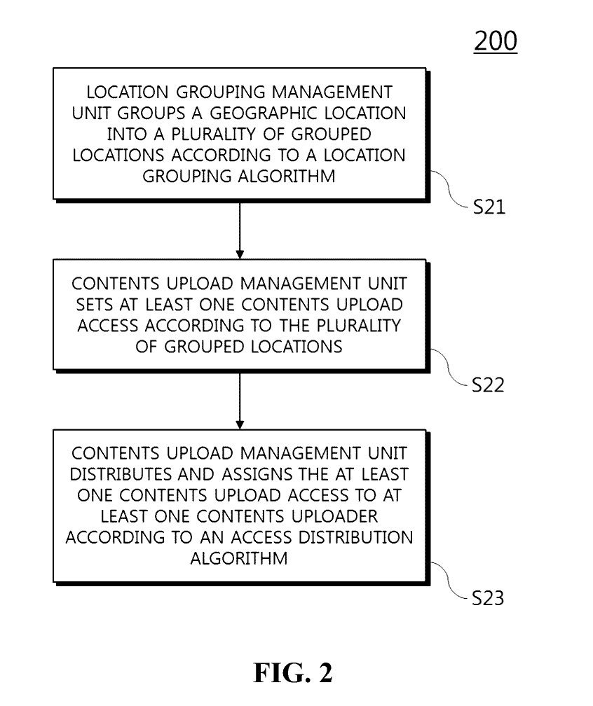

FIG. 2 is a flowchart illustrating a location-grouping contents management method according to the embodiment of the present disclosure. For example, the location-grouping contents management method 200 according to an embodiment of the present disclosure shown in FIG. 2 may be performed by the location-grouping contents management server 110 described above with reference to FIG. 1.

Referring to FIG. 2, the location-grouping contents management method 200 according to an embodiment of the present disclosure may include the step of grouping a certain geographic location into a plurality of grouped locations according to a location grouping algorithm by the location grouping management unit 111 (step S21). The location grouping algorithm may group the geographic location according to at least one of latitude, longitude, administrative district, zip code and address. For example, the location grouping algorithm may be set by a manager of the location-grouping contents management server 110.

Next, the location-grouping contents management method 200 according to an embodiment of the present disclosure may include the step of setting at least one contents upload access according to the plurality of grouped locations by the contents upload management unit 113 (step S22). According to embodiments, the contents upload management unit 113 may set the at least one contents upload access according to the plurality of grouped locations and at least one contents classification, as described above with reference to FIG. 1.

Next, the location-grouping contents management method 200 according to an embodiment of the present disclosure may include the step of distributing and assigning at least one contents upload access to at least one contents uploader according to an access distribution algorithm by the contents upload management unit 113 (step S23).

The contents upload management unit 113 may receive at least one access assignment application from the contents upload terminal 150 of the at least one contents uploader, and if the at least one access assignment application is overlapped in any one of the grouped location and the contents classification, the contents upload management unit 113 may assign a contents upload access corresponding to the any one of the grouped location and the contents classification to at least one of the contents uploaders transmitting the overlapped access assignment application according to the access distribution algorithm. In addition, the access assignment application may include information on a grouped location selected among the plurality of grouped locations and information on a contents classification selected in the selected grouped location.

Since specific descriptions of steps S21, S22 and S23 are similar to those described above with reference to FIG. 1, detailed description thereof is omitted.

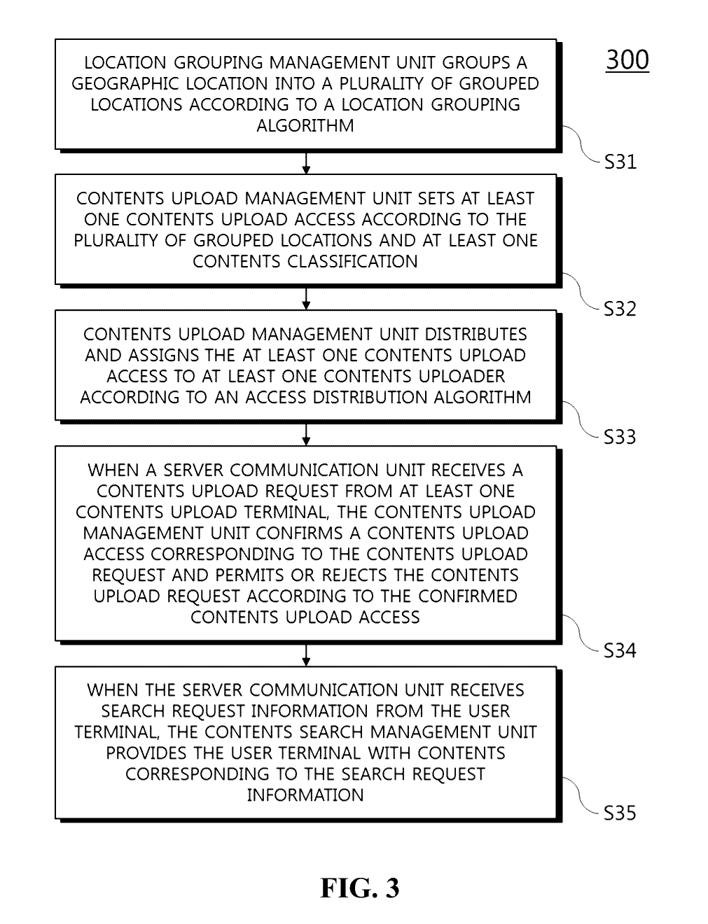

FIG. 3 is a flowchart illustrating a location-grouping contents management method according to another embodiment of the present disclosure. For example, the location-grouping contents management method 300 according to another embodiment of the present disclosure shown in FIG. 3 may be performed by the location-grouping contents management server 110 with reference to FIG. 1.

Referring to FIG. 3, the steps S31, S32 and S22 included in the location-grouping contents management method 300 according to another embodiment of the present disclosure may be respectively similar to the steps S21, S22 and S23 described above with reference to FIG. 2. Although step S32 of FIG. 3 is disclosed to set at least one contents upload access by the contents upload management unit 113 according to the plurality of grouped locations and at least one contents classification, as described above with reference to FIGS. 1 and 2, the contents upload management unit 113 may set at least one contents upload access according to the plurality of grouped locations.

Next, the location-grouping contents management method 300 according to another embodiment of the present disclosure may further include the step of confirming, when the server communication unit 115 receives a contents upload request from the contents upload terminal 150, a contents upload access corresponding to the contents upload request and permitting or rejecting the contents upload request according to the confirmed contents upload access by the contents upload management unit 113 (step S34). The contents upload request may be generated by the contents upload terminal 150 according to a contents upload form provided by the contents upload management unit 113.

Next, the location-grouping contents management method 300 according to another embodiment of the present disclosure may further include the step of providing, when the server communication unit 115 receives search request information from the user terminal 170, the user terminal 170 with contents corresponding to the search request information by the contents search management unit 117. A user may connect to a web site provided by the contents search management unit 117 through the user terminal 170 and transmit the search request information to the server communication unit 115. The user may transmit the search request information to the server communication unit 115 through an application downloaded from the software application management unit 118. The search request information may include location selection information corresponding to at least one of the plurality of grouped locations, and the location selection information may be received from the user through the user terminal 170 or correspond to the location of the user terminal 170.

Since specific descriptions of steps S34 and S35 are similar to those described above with reference to FIG. 1, detailed description thereof is omitted.

Meanwhile, the location-grouping contents management method according to the present disclosure may be executed by a computer program stored in a medium to execute the location-grouping contents management method described above with reference to FIGS. 2 and 3 in combination with hardware.

FIG. 4 illustrates a map for an explanation of a location grouping algorithm according to an embodiment of the present disclosure. As shown in FIG. 4, the location grouping algorithm according to an embodiment of the present disclosure may group a specific location 400 into twenty four grouped locations according to three latitude lines 411, 412 and 413 and five longitude lines 431, 432, 433, 434 and 435. A contents upload access may be set to each of the twenty four grouped locations by the location-grouping contents management system and method described above with reference to FIGS. 1 to 3, and the contents upload access may be assigned to various contents uploaders.

Meanwhile, grouping the specific location 400 according to the latitude and longitude lines in FIG. 4 is only for illustrative purpose, and the specific location 400 may be grouped using straight lines of diagonal directions or curved lines rather than the straight lines according to embodiments.

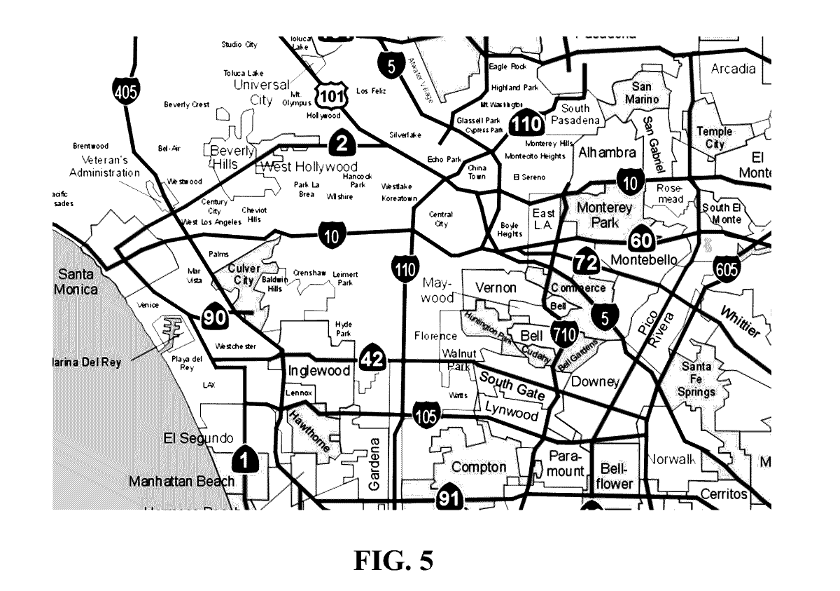

FIG. 5 illustrates a map for an explanation of a location grouping algorithm according to another embodiment of the present disclosure. FIG. 5 is a view showing a corresponding location grouped based on the administrative districts around Los Angeles, and the location grouping algorithm according to another embodiment of the present disclosure may group the corresponding location into a plurality of grouped locations based on the administrative districts such as a city, a county and the like.

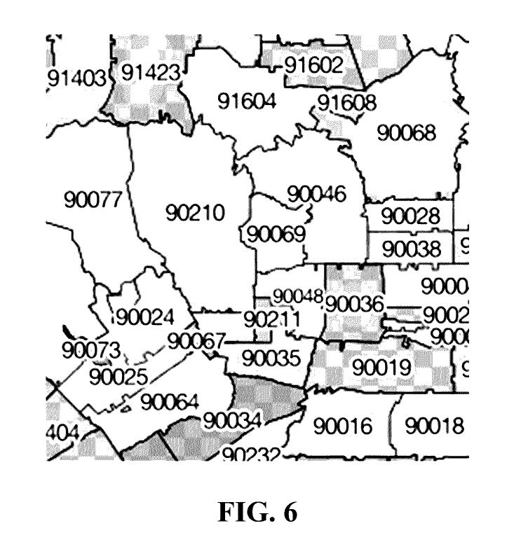

FIG. 6 illustrates a map for an explanation of a location grouping algorithm according to another embodiment of the present disclosure. FIG. 6 is a view showing the West Hollywood location of California grouped based on the zip code, and the location grouping algorithm according to another embodiment of the present disclosure may group the corresponding location into a plurality of grouped locations based on the zip code.

On the other hand, the location-grouping contents management system and method according to an embodiment of the present disclosure may group a location in a variety of methods, other than the location grouping algorithms described above, such as setting a location surrounding a specific road or building as a grouped location, and the location grouping algorithms described above may be used in a manner combined with each other, such as sub-grouping an administrative district based on latitude and longitude. The location-grouping contents management system and method according to an embodiment of the present disclosure may group the corresponding location into a plurality of grouped locations based on each single address. That is, the location-grouping contents management system and method according to an embodiment of the present disclosure may set a single address as a grouped location and set at least one contents upload access according to the each single address.

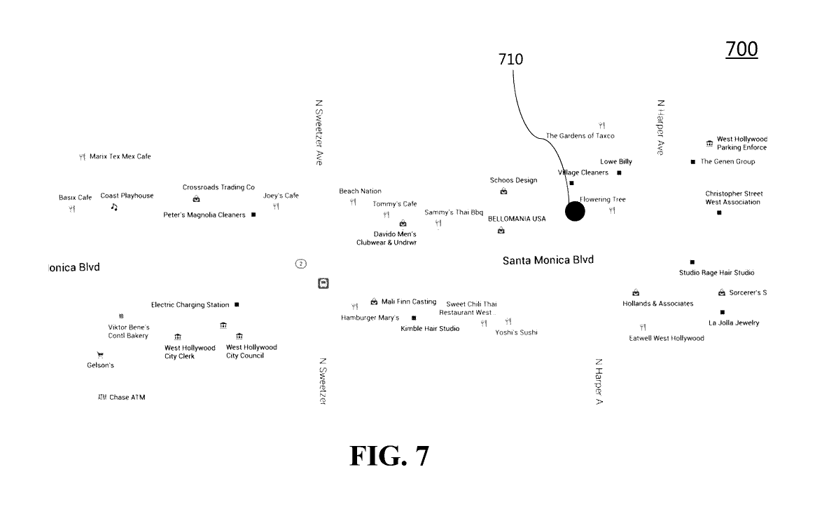

FIG. 7 illustrates a map showing a screen provided on a contents upload terminal according to an embodiment of the present disclosure.

When a contents uploader communicates with the location-grouping contents management server 110 and uploads contents related to a grouped location onto the location-grouping contents management server 110 using its own contents upload terminal 150, the contents upload terminal 150 may receive the location corresponding to the contents to be uploaded from the contents uploader. Accordingly, as shown in FIG. 7, the contents upload terminal 150 may display the location 710 corresponding to the contents to be uploaded on a display unit using an internet map service or the like.

FIG. 8 illustrates a table and picture showing a contents upload form according to an embodiment of the present disclosure. The contents upload form 800 shown in FIG. 8 may be displayed through the display unit of the contents upload terminal 150 when a contents uploader connects to the contents upload management unit 113 through its own contents upload terminal 150 and enters into a contents upload request screen.

As shown in FIG. 8, a contents uploader may select any one contents classification among the contents classifications 810 including restaurant, real estate, accommodation, market and bank. In addition, if the contents uploader selects the real estate among the at least one of the contents classifications 810, any one of Sale and Lease may be selected among the contents sub-classifications 820.

In addition, the contents uploader may select detailed contents information desired to input among the detailed contents information 830 including location, address, interior view and exterior view, select a picture or moving image contents from the contents type selection window 840 and press the upload button 860. In addition, the contents upload form 800 may provide a thumbnail image 850 of a picture or a moving image to be uploaded by the user, and if the user clicks the upload button 860, a contents upload request including the input contents classification 810, the contents sub-classification 820, the detailed contents information 830, the uploaded picture 850 and the like is generated and transmitted to the contents upload management unit 113. Accordingly, real estate contents including the interior view of real estate as shown in FIG. 8 may be uploaded onto the location-grouping contents management server 110. Meanwhile, the contents upload form shown in FIG. 8 is an illustrative screen and can be diversely modified within a scope known to those skilled in the art.

The system, the server and the method for managing contents based on location grouping according to the present disclosure as described above have an effect of uploading contents information appropriate to each location from the contents uploader of a corresponding location by grouping a specific location into a plurality of grouped locations according to a location grouping algorithm, setting a contents upload access according to the plurality of grouped locations and a contents classification, and distributing and assigning the contents upload access to at least one contents uploader according to an access distribution algorithm.

In addition, the system, the server and the method for managing contents based on location grouping according to the present disclosure as described above have an effect of obtaining the best contents information on a specific location, which cannot be obtained from a general internet portal site.

The diverse embodiments disclosed in this specification may be implemented by hardware, middleware, microcode, software and/or a combination thereof. For instance, the diverse embodiments may be implemented within one or more of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electronic units designed to perform the functions presented herein or a combination thereof.

In addition, for example, the diverse embodiments may be recorded or encoded in computer-readable media including commands. The commands recorded or encoded in the computer-readable media may make a programmable processor or other processors perform a method when, for example, the commands are executed. The computer-readable media include all kinds of communication media including a computer storage medium and a certain medium which makes it easy to transfer a computer program from one place to another place. The storage medium may be a certain available medium accessible by a computer. For example, such computer-readable media may include RAM, ROM, EEPROM, CD-ROM or other optical disk storage media, magnetic disk storage media or other magnetic storage devices, or other certain media which can be used to return or store a desired program code in the form of commands or data structures accessible by a computer.

Such hardware, software, firmware, and the like may be implemented within a same device or individual devices to support diverse operations and functions described in this specification. Additionally, the constitutional elements, units, modules, components and the like described as “unit” in the present disclosure may be implemented together or individually as interoperable logic devices although individual. Description of different features of the modules, units and the like is intended to emphasize functional embodiments different from each other and does not necessarily mean that these should be realized by individual hardware and software components. Rather, a function related to one or more modules or units may be performed by individual hardware and software components or may be integrated in common or individual hardware and software components.

Although operations are shown in the figures in a specific order, it should not be understood in such a way that these operations need to be performed in a specific order or a sequential order or all the operations shown in the figures should be performed to accomplish a desired result. In a certain environment, multi-tasking and parallel processing may be advantageous. Furthermore, it should not be understood in such a way that classification of the diverse constitutional elements shown in the embodiment described above is needed in all embodiments, and it should be understood that the described constitutional elements may be generally integrated together as a single software product or packaged as a plurality of software products.

Although the present disclosure has been described with reference to the embodiments shown in the figures, those skilled in the art can make various modifications and other equivalent embodiments therefrom. Accordingly, the true scope of the present disclosure should be defined by the technical spirit of the appended claims.

What is claimed is:

1. A location-grouping contents management system comprising:
a location-grouping contents management server;
at least one contents upload terminal; and
at least one user terminal,
wherein the location-grouping contents management server comprises:
a location grouping management unit for grouping a geographic location into a plurality of grouped locations according to a location grouping algorithm, and
a contents upload management unit for setting at least one contents upload access according to the plurality of grouped locations and at least one contents classification, and
distributing and assigning the at least one contents upload access to at least one contents uploader according to an access distribution algorithm;
wherein the at least one contents upload terminal corresponds to the at least one contents uploader and communicates with the location-grouping contents management server to upload contents corresponding to the contents upload access assigned to the corresponding contents uploader, and
the at least one user terminal transmits search request information received from a user to the location-grouping contents management server and to receive contents corresponding to the search request information among the contents uploaded onto the location-grouping contents management server.

2. A location-grouping contents management server comprising:
a location grouping management unit for grouping a geographic location into a plurality of grouped locations according to a location grouping algorithm; and
a contents upload management unit for setting at least one contents upload access according to the plurality of grouped locations, and distributing and assigning the at least one contents upload access to at least one contents uploader according to an access distribution algorithm.

3. The server according to claim 2, wherein the contents upload management unit sets the at least one contents upload access according to the plurality of grouped locations and at least one contents classification.

4. The server according to claim 3, further comprising a server communication unit for receiving a contents upload request from a contents upload terminal, wherein the contents upload management unit confirms a contents upload access corresponding to the contents upload request and to permit or reject the contents upload request according to the contents upload access, which is confirmed by the contents upload management unit.

5. The server according to claim 4, wherein the contents upload terminal generates the contents upload request according to a contents upload form provided by the contents upload management unit.

6. The server according to claim 4, further comprising a contents search management unit that provides the user terminal with contents corresponding to search request information when the server communication unit receives the search request information from a user terminal.

7. The server according to claim 6, wherein the search request information includes location selection information corresponding to at least one of the plurality of grouped locations, and the location selection information is received from the user through the user terminal or the location selection information corresponds to a geographical location of the user terminal.

8. The server according to claim 6, further comprising a software application distribution management unit that distributes and manages a software application for connecting the user terminal to the location-grouping contents management server,
wherein the user terminal transmits the search request information to the location-grouping contents management server and to receive contents corresponding to the search request information through the software application downloaded from the software application distribution management unit.

9. The server according to claim 3, wherein the location grouping algorithm groups the geographic location according to at least one of latitude, longitude, administrative district, zip code, and address.

10. The server according to claim 3, wherein the contents upload management unit receives at least one access assignment application from a contents upload terminal of the at least one contents uploader, and if the at least one access assignment application is overlapped in any one of the grouped location and the contents classification, the contents upload management unit assigns a contents upload access corresponding to the any one of the grouped location and the contents classification to at least one of contents uploaders transmitting the overlapped access assignment application according to the access distribution algorithm.

11. The server according to claim 10, wherein the access assignment application includes information on a grouped location selected among the plurality of grouped locations and information on a contents classification selected in the selected grouped location.

12. A location-grouping contents management method comprising:
grouping a geographic location into a plurality of grouped locations according to a location grouping algorithm, by a location grouping management unit;
setting at least one contents upload access according to the plurality of grouped locations, by a contents upload management unit; and
distributing and assigning the at least one contents upload access to at least one contents uploader according to an access distribution algorithm, by the contents upload management unit.

13. A location-grouping contents management method comprising:
grouping a geographic location into a plurality of grouped locations according to a location grouping algorithm, by a location grouping management unit;
setting at least one contents upload access according to the plurality of grouped locations and at least one contents classification, by a contents upload management unit; and
distributing and assigning the at least one contents upload access to at least one contents uploader according to an access distribution algorithm, by the contents upload management unit.

14. The method according to claim 13, further comprising confirming, when a server communication unit receives a contents upload request from a contents upload terminal, a contents upload access corresponding to the contents upload request; and
either permitting or rejecting the contents upload request according to the contents upload access, which is confirmed by the contents upload management unit.

15. The method according to claim 14, wherein the contents upload terminal generates the contents upload request according to a contents upload form provided by the contents upload management unit.

16. The method according to claim 14, further comprising providing, when the server communication unit receives search request information from a user terminal, the user terminal with contents corresponding to the search request information, by a contents search management unit.

17. The method according to claim 16, wherein the search request information includes location selection information corresponding to at least one of the plurality of grouped locations, and the location selection information is received from the user through the user terminal or the location selection information corresponds to a geographical location of the user terminal.

18. The method according to claim 13, wherein the location grouping algorithm groups the geographic location according to at least one of latitude, longitude, administrative district, zip code, and address.

19. The method according to claim 13, wherein the contents upload management unit receives at least one access assignment application from the contents upload terminal of the at least one contents uploader, and if the at least one access assignment application is overlapped in any one of the grouped location and the contents classification, the contents upload management unit assigns a contents upload access corresponding to the any one of the grouped location and the contents classification to at least one of contents uploaders transmitting the overlapped access assignment application according to the access distribution algorithm.

20. The method according to claim 19, wherein the access assignment application includes information on a grouped location selected among the plurality of grouped locations and information on a contents classification selected in the selected grouped location.

21. A non-statutory computer-readable medium for location-grouping contents management method, comprising instructions stored thereon, that when executed on a processor, perform the steps of:
grouping a geographic location into a plurality of grouped locations according to a location grouping algorithm, by a location grouping management unit;
setting at least one contents upload access according to the plurality of grouped locations and at least one contents classification, by a contents upload management unit; and
distributing and assigning the at least one contents upload access to at least one contents uploader according to an access distribution algorithm, by the contents upload management unit.
